(19) United States
(12) Patent Application Publication
(10) Pub. No.: US 2026/0305867 A1
(43) Pub. Date: Oct. 8, 2026

(54) COOKWARE SURFACE

(71) Applicant: Imperial Great British Design Limited, Leicester (GB)

(72) Inventor: Zane Bham, Leicester (GB)

(21) Appl. No.: 19/482,957

(22) PCT Filed: May 14, 2024
(86) PCT No.: PCT/GB2024/051252

§ 371 Date: Nov. 10, 2025

(30) Foreign Application Priority Data
May 15, 2023 (GB) 2307213.5

(51) Int. Cl. A47J 36/02; B21K 21/00

(52) U.S. Cl. CPC A47J 36/025; B21K 21/00

(57) ABSTRACT

A cookware article with a textured surface and a method for producing the same. The method comprising performing a first forging step to create a three-dimensional body of the article of cookware from a sheet material having first and second opposing major surfaces, wherein the three-dimensional body comprises a concave form in which the first surface comprises an internal surface and the second surface comprises an external surface, performing a second forging step on the three-dimensional body to impart a surface texture over the internal surface, applying a non-stick coating to the textured internal surface.

The present invention relates to a cookware surface, particularly to a textured cookware surface and a method for producing a corresponding article of cookware, such as a pan.

### INTRODUCTION

The addition of a non-stick coating to the surface of pots and pans allows food to be cooked with little oil or fat and reduces cleaning time. However, with regular cleaning and utensils scraping at the cookware surface, many non-stick coatings tend to wear off through use due to abrasion or delamination. Over time the surface will lose its non-stick qualities. Further the non-stick coating can flake or peel into the food being cooked.

It is known to texture the cookware surface using sand blasting, shot peening, or the like prior to application of a surface coating. In this manner the article of cookware has depressions over its surface, which can then be covered with the desired surface coating. The presence of the surface coating within the depressions can increase the life of the surface coating due to it being less prone to abrasion or degradation with use. However the treatment of the surface adds significant cost to the manufacturing process, thus impacting the price of the product.

It is also known to provide a series of regularly distributed ribs over the flat base of a pan to reduce sticking in use. These patterns are generally made by stamping on an aluminium plate when forming the pan body and, in some examples, a non-stick coating is then applied. However it has been found that these regular patterns/lines of ribs can also be subject to repetitious wear over time, i.e. due to their common alignment. Furthermore, there are limits on the geometry of the ribs that can be applied using conventional stamping techniques.

There is need for a cookware surface which retains a non-stick surface through prolonged use. It is an aim of the present invention is to provide a cookware surface that mitigates or resolves the above identified problems.

### Statements of Invention

According to a first aspect of the invention there is provided a method for producing an article of cookware comprising: performing a first forging step to create a three-dimensional body of the article of cookware from a sheet material having first and second opposing major surfaces, wherein the three-dimensional body comprises a concave form in which the first surface comprises an internal surface and the second surface comprises an external surface; performing a second forging step on the three-dimensional body to impart a surface texture over the internal surface; applying a non-stick coating to the textured internal surface.

The second forging step may impart the surface texture over substantially the entire area of the internal surface. The second forging process may impart the surface texture over at least 80%, 85%, 90% or 95% of the internal surface.

The three-dimensional body created by the first forging step may comprise a base and a side/peripheral wall. The wall may be angled relative to the base. The side wall may be curved in profile.

The second forging step may impart the surface texture over the base and side wall. The internal surface texture may extend continuously and/or uniformly over the base and the side wall. The surface texture may be imparted over a curved portion or profile of the side wall.

The first forging process may create a near net shape for a body of the article of cookware. The body may comprise a pan body.

The method may comprise roughening the internal surface. Roughening of the internal surface may be carried out after the second forging step and/or before the application of the non-stick coating.

The roughening may comprise applying a further surface texture over the internal surface. The further surface texture may be of a length scale that is smaller than the length scale of the surface texture, e.g. at least an order of magnitude smaller. The further surface texture may follow the contour of the surface texture.

The roughening of the internal surface may improve keying/adhesion of the non-stick coating thereto.

The first and/or second forging step may be carried out at a controlled and/or elevated temperature. The sheet material and/or three-dimensional body is preferably heated during the first and/or second forging step. The first and second forging step may be performed at substantially the same temperature or different temperatures.

The first forging step may be carried out using a first press member. The second forging step may be carried out using a second press member. The second press member may have the surface texture thereon, e.g. the inverse of the surface texture imparted onto the internal surface.

The first and second forging steps may be performed by actuating a press member in a common direction, e.g. an axial direction.

The surface texture may comprise an irregular pattern of raised shapes spaced by grooves/valleys therebetween The raised shapes may themselves be irregular. The pattern may be amorphous in form and/or non-repeating.

The raised shapes may be generally polygonal in plan. The raised shapes may comprise three-sided and/or four-sided shapes in plan. The shapes may have straight and/or curved edges.

The grooves may be interconnected, e.g. in the form of a continuous network. The grooves may surround each raised shape.

According to a second aspect of the invention there is provided an article of cookware with a textured internal surface created according to the method of the first aspect of the invention.

The article of cookware may comprise a pan or pan body.

### DETAILED DESCRIPTION

Practicable embodiments of the invention are described in further detail below with reference to the accompanying drawings, of which:

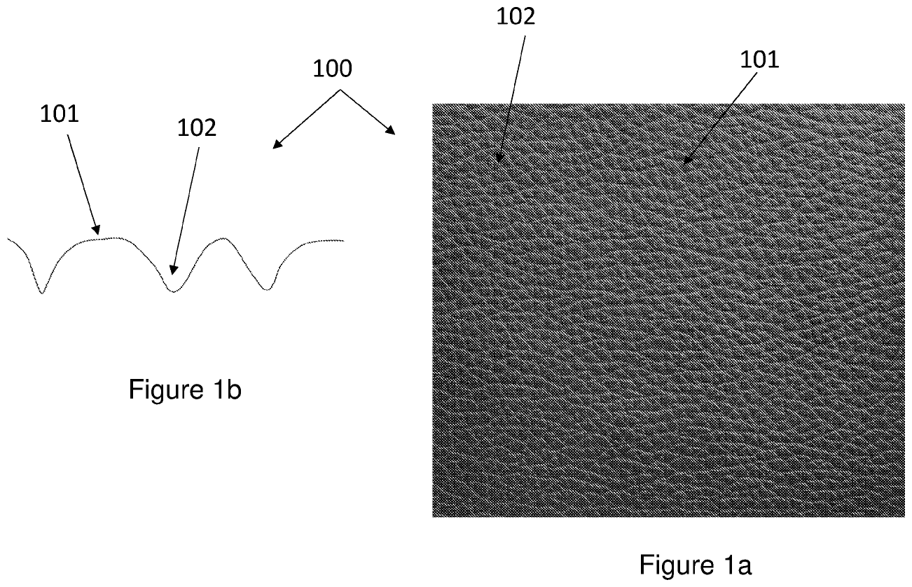

FIG. 1a shows a top view of an internal cookware surface according to the invention;

FIG. 1b shows a schematic section view through a surface texture of the cookware surface;

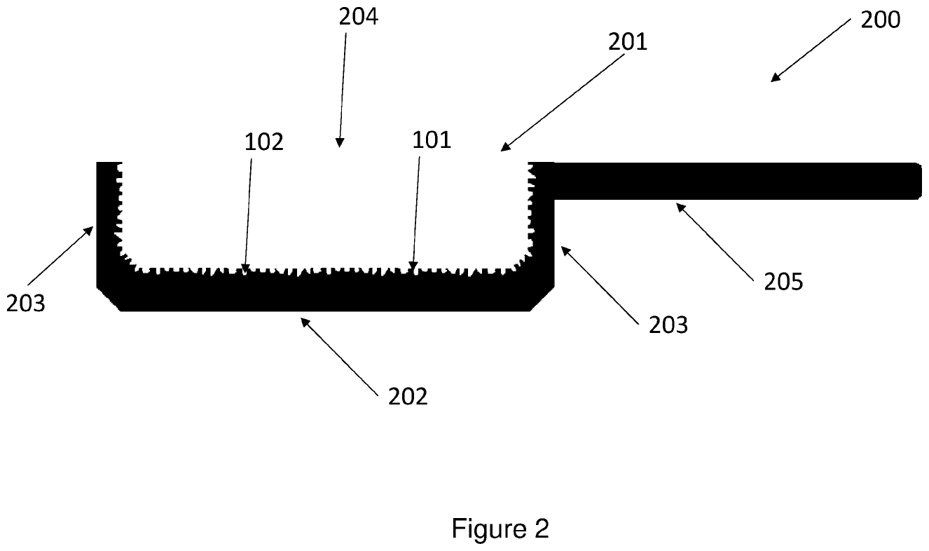

FIG. 2 shows a cross sectional view of the cookware according to the invention;

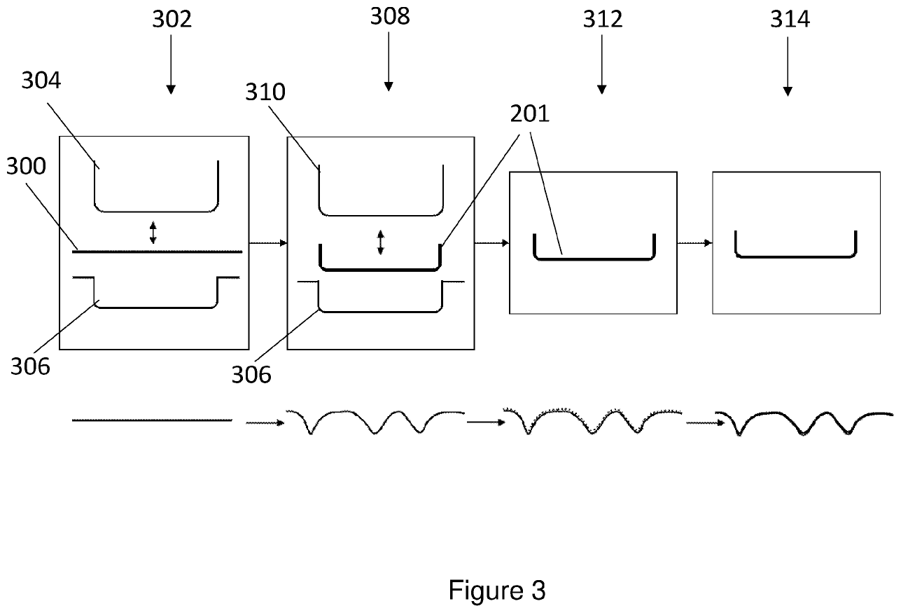

FIG. 3 shows a schematic overview of the manufacturing process.

### INTERNAL SURFACE TEXTURE

FIG. 1 shows a top view of an internal cookware surface 100 according to the invention.

The surface 100 comprises a texture. The texture comprises a plurality of raised portions 101. Between the raised portions 101 are indented portions 102, in the form of creases, troughs, valleys, grooves or the like.

The raised portions 101 are discrete portions in that they are completely surrounded by indented portions. The indented portions 102 are continuous so as to create channels or valleys between the raised portions 101. A continuous network of valleys over the surface is defined.

The indented portions 102 separate adjacent raised portions 101.

The raised portions 101 and indented portions 102 are provided in an irregular pattern creating a “creased” or “leather” effect on the cookware surface. The irregular pattern may be an ad hoc pattern and/or it may be a repeated pattern.

The raised portions 101 comprise irregular shapes and may be described as amorphous shapes, e.g. having generally polygonal form but optionally comprising one or more curved edge.

The raised portions 101 may each have a flat central portion between the indented portions 102 along its sides/edges. Alternatively, the raised portions may be arched or domed in profile so as to present a minimal flat upper surface. In any example, the raised portions typically have curved sides as can be seen in FIG. 1b. The sides are steepest towards the bottom of each valley and curve towards a shallowest/flattest gradient towards the centre of the raised portion 101.

The raised portions 101 are of varying width over the surface 100. The width of the raised portions may be in the in the order of 1 mm. For example the minimum width of the raised portions may be 0.5 mm or 1 mm. The maximum width of the raised portions may be 2 mm, 3 mm, 4 mm, 5 mm, 6 mm, 7 mm, 8 mm, 9 mm or 10 mm. The width of the raised portions may vary between the maximum and minimum values over the surface 100. The width of the raised portions 101 may vary in a random or pseudo-random manner over the surface 100, e.g. in an amorphous or ad-hoc pattern that does not follow a mathematically defined or repeating pattern.

The height of the raised portions 101 and/or depth of the indentations 102 may be of the order of 1 mm. For example the height depth may be between 0.1 mm, 0.2 mm or 0.3 mm and 1 mm, 1.5 mm or 2 mm. The height of the raised portions is relatively consistent and/or uniform over the surface. For example, the peaks of the raised portions 101 may lie in a generally flat plane and/or the bottom of the indentations 102 may lie in a flat plane or at a generally common depth.

In other examples the indented portions 102 may vary in depth between the maximum and minimum values given above.

The width of the indentations 102 may be more uniform than the width of the raised portions 101, and may for example be generally uniform, e.g. within suitable tolerances.

The raised portions 101 vary in area across the pattern (e.g. when viewed in plan). All indented portions 102 may connect to around the raised portions 101 to create a series of peaks and troughs through the surface when viewed in section. The plan area of the cookware surface 100 occupied by the raised portions 101 may be greater than or equal to the area occupied by the indented portions 102.

The ratio of raised portions to dented portions of surface area may be in the region of 1:1, 4:3, 3:2, 2:1, 3:1 or 4:1.

Whilst the surface 100 described herein is generally irregular or amorphous, it is formed by a press member of a forging process as will be described below. Thus the surface pattern is predetermined despite its ad-hoc or pseudo-random appearance.

FIG. 2 shows a cross sectional view of an article of cookware 200 according to the invention. The article of cookware 200 comprises a pan in this example but could potentially comprise an article of bakeware, such as a tin or tray, in other examples.

The article of cookware 200 comprises a pan body 201 shaped so as to define a base 202 and a peripheral side wall 203 surrounding the base 202. Depending on the type of pan, the height and angle of inclination of the side wall 203 could vary, as could the area of the base. However all pan bodies 201 typically have a smooth/curved interface or transition between the base and side wall. The curvature thereof may vary, again, based on the type or depth of pan and the inclination of the side wall 203. The pan body shown has a side wall 203 that is substantially perpendicular to the base 202.

In other examples, the pan need not be circular in plan and so the peripheral side wall 203 may be made up of a plurality of adjoining side walls 203. A polygonal, e.g. quadrilateral, pan body could be used. In any such arrangement, the corners of the pan may be rounded. The sides also need not be straight but could be bowed.

FIG. 2 shows just one example of the shape of the cookware. The cookware may comprise any suitable shape, e.g., the cookware may comprise a base and no sides, or the side wall could be shallow, e.g. in the form of a rim or flange.

The internal surface is the surface on which food is placed to be cooked in use.

The article of cookware 200 comprises a handle 205 depending from the side wall 203. The internal surface 204 of the cookware comprises the inner side of the base 202 and sides 203. The external surface comprises the outer sides of the base 202 and sides 203.

In FIG. 2, the internal surface 204 of the cookware 200 comprises the texture described above with a plurality of raised portions 101 and indented portions 102. The pattern is continuous and covers the entirety of the inner side of the base 202 and the side wall 203. In other examples, the pattern may be present on at least 90% of the internal surface.

Whilst it is possible to provide the surface texture/pattern over the external surface of the body 201, the surface texture is typically not present on the external side of the pan body. The external side of the pan may be substantially smooth, or it may comprise a different texture to that of the internal side.

The surface has a non-stick coating which is not visible in FIGS. 1-2. The coating has a thickness of less than 100 μm or 50 μm, e.g. being in the range of 20 μm to 30 μm. The non-stick coating follows the contour/profile of the surface texture described above and does not interrupt the texture of the surface created by the pattern. That is to say, the surface coating is of a depth such that it does not fill the indentations 102 but is sufficiently thin and/or uniform in depth that the surface of the non-stick coating follows the underlying surface profile in the material of the pan body.

In some examples, the non-stick coating may partially fill the indentations 102. However the non-stick coating is preferably uniform in thickness, e.g. within typical tolerances.

The coating is preferably of the PTFE type, although any suitable non-stick coating could be used.

In addition to the texture provided by the pattern of raised and indented portions, the internal surface of the cookware is microscopically textured to receive the surface coating as will be described below. The microscopic texture provides a rough surface on top of the pattern. The texture of the cookware surface comprises both a macroscopic and microscopic texture prior to application of the surface/non-stick coating. The coating may smooth over the microscopic texture such that it is not present in the outer surface of the coating once applied.

Attachment of the coating is facilitated by the microscopic texture which improves the adhesion of the non-stick coating.

The non-stick coating covers both the raised portions 101 and the indented portions 102. As such the internal surface is entirely coated with the non-stick coating.

The irregular distribution of raised portions 101 and dented portions 102 has the effect of improving the wear resistance of the non-stick coating on the cookware surface. This property is particularly important when the base 202 and sides 203 of the cookware 200 are made of aluminium, which is relatively soft and susceptible to scratches created by harder metal objects, such as utensils. However the pan body could be formed of any conventional metal sheet material.

Due to the texture created by the pattern, the surface is only scratched in use at irregular distinct points at the peaks of the raised portions 101, having little effect on the overall non-stick quality of the cookware and preventing the coating from peeling or flaking.

The coating within the cavities created by the dented portions 102 is unlikely to be disturbed in use by scratches or the like and will remain mostly intact throughout the lifetime of the cookware.

### Method of Manufacture

With reference to FIG. 3, the method of manufacture of the cookware 200 is described below. In FIG. 3, below the manufacturing stage there is shown a schematic of the cookware surface texture created by that stage.

An aluminium blank 300, i.e. an aluminium sheet, is the initial state of the material used to form the pan body. Alternatively, the blank may comprise any suitable material for cookware, for example, stainless steel, copper, or carbon steel. Both faces of the blank 300 are oiled prior to forging.

### First Forging of the Blank 302

The blank goes through a first forge. This is where the blank is forged into the near net shape of the cookware 200, i.e. a three-dimensional form of the cookware body 201 is imparted into the blank. The blank 300 may be shaped into any shape suitable for the intended use of the cookware as described above, having a side wall and a base.

The blank 300 is deformed away from its flat shape into the three-dimensional profile by a press member or die 304, which corresponds to the desired net shape of the internal surface of the pan body 201. The internal and external surfaces are commonly deformed into the near net shape. The die 304 presses the blank 300 into a cavity 306 which corresponds to the desired net shape of the exterior of the pan body 201. The die 304 is driven to force the blank into the cavity 306.

The first forge 302 is performed at an elevated temperature to improve the response of the blank to the pressing process. This reduces stress/strain in the body during the pressing process and residual stress in the body once formed. The forging temperature will be dependent on the material used but is below the melting point of the material. For aluminium, the forging temperature may be greater than 400 or 500 °C. The temperature is controlled during the forging step, e.g. within a temperature controlled environment/enclosure.

In the example shown, the die 304 and cavity are heated to the desired temperature. The blank is pressed at a suitable rate and held in its deformed state in the cavity for a suitable dwell time to ensure the desired temperature of the blank in its deformed condition is achieved. The blank 300 has now been formed into the desired near net shape of the body 201. The body 201 is concave in form but still has a plain surface texture in this state.

The press member 304 is retracted.

### Second Forging 308

The cookware goes through a second forge where the surface pattern texture, e.g. with a “creased” or “leather” effect, is pressed onto the internal surface 204.

Specially designed tooling is used in the second forge. In this regard, a second press member or die 310 is used for the second forge, which is different form the first forge. The body 201 may be maintained in the cavity 306 or transferred to a different cavity.

The second forge is performed at a controlled elevated temperature in a manner similar to the first forge. The temperature of the second forging step may be the same as, or different from the first forging temperature, e.g. being higher or lower.

The cavity and press member may be 310 may be held/controlled at the desired second forge temperature. The temperature may be a ‘finishing forge’ temperature, i.e. being lower than the first forge temperature used for gross deformation of the blank. The dwell time and force of the press member may also be adjusted to achieve the finer detail of the surface texture imparted into the body 201 during this stage.

The internal surface is preferably made of aluminium which is a relatively soft material which can be stamped by a die.

Based on experimentation with applied force/pressure using the press as well as the temperature and dwell time, it has been found that it is possible to apply the desired surface texture not only to the base 202 but also the side wall 203 of the body 201 using the die 310. This includes the curved transition between the flat base and side walls. Thus the desired surface pattern can be applied over the entire internal surface as a simple, single additional forging step.

The second forge only textures the internal surface 204 of the cookware 200 in a macroscopic sense and does not create any texture on the external surface in this example.

The pattern for the macroscopic surface texture is engraved on the die as an inverse image of the texture which it is desired to print on the internal surface of the cookware 200 by subsequent die-stamping. The pattern on the die is continuous over the end face of the die and around the curved die periphery, e.g. including up the side walls of the die.

The tooling is calibrated with accuracy such that the second forge creates a clear texture on the entire internal surface, such that the bottom of the pan and the sides of the pan are textured with the predetermined pattern dictated by the tooling used.

With regards to the effectiveness of the second forging step, it is noted that the inverse of the surface texture has relatively ‘sharp’ ridges and rounded depressions to create the profile of valleys and raised portions in the body surface. As such the ridges in the die tool are effective at deforming the softer aluminium material of the body in a repeatable fashion that does not significantly degrade the tool geometry.

### Preparation of the Textured Body

Excess material is cut from the rim of the cookware body 201 after the second forging step. This defines the rim of the pan body to ensure a consistent shape is achieved.

Excess material is also cut from the bottom of the cookware 200.

The cookware body 201 goes through a washing process.

If the cookware 200 is to be suitable for use as induction cookware, an induction hole is created in the base 202. It is at this stage in the method of manufacture that an induction hole will be attached to the cookware 200.

### Surface Roughening 312

The internal surface of the cookware undergoes sandblasting in this example. This creates the microscopic texture on the internal surface of the cookware without disturbing the macroscopic pattern created by the second forge. The microscopic texture creates a roughness to the internal surface with a length scale of the order of 10 μm or 20 μm or less. The width of individual indentations creating the surface roughness may be between 1 μm and 10 μm, for example between 3 μm and 8 μm.

The roughness can be altered by using different types of sand or other projectile type. The surface roughness can alternatively be obtained by another roughening method, e.g., shot blasting, chemical corrosion, or electrochemical corrosion, etc.

The entire interior surface of the body may be treated for surface roughening. In the example of sand blasting or the like, varying angles or attack may be used to treat the three-dimensional internal surface, e.g. to roughen the curved surface regions and side walls.

After roughening, the surface of the cookware body goes through a second washing process.

### Application of Non-Stick Coating 314

The non-stick coating is applied to the entire internal surface of the cookware.

The non-stick coating is applied at a thickness of less than 50 μm, for example 20 μm to 30 μm, so the coating will not significantly diminish the pattern created by the second forge. The non-stick coating thus follows the contour of the macroscopic surface texture over the raised portions 101 and the indentations 102 alike. The coating layer thickness is generally uniform over the internal surface of the body 201.

Any conventional application process can be used for the non-stick coating application provided it can provide the desired uniform layer. Whilst partial filling of the indentations 102 is possible during the coating application, it is preferred that a majority of the volume of indentations 102 is open/unfilled. As such the indentations are present as recesses in the final surface finish and the textured surface is visible to the eye after coating.

The roughened, microscopic texture helps ensure reception and adherence of the non-stick coating to the surface of the body 201. The roughened texture presents an increased surface area for adherence and varying angle of the surface at a microscopic level so that the non-stick coating cannot delaminate or easily detach from the underlying surface.

### Finishing

Any, any combination, or all of the following steps may be performed to achieve the final form of the cookware product:
Application of a coating to the external side of the cookware.
Bottom polish.
The external side wall undergoes polishing.
The attachment of one or more handle using conventional process, e.g. using fasteners
The addition of a non-conductive material to the handle
The addition of logos to the cookware, or decoration to the external side of the cookware.

1. A method for producing an article of cookware with a textured internal surface comprising:
performing a first forging step to create a three-dimensional body of the article of cookware from a sheet material having first and second opposing major surfaces, wherein the three-dimensional body comprises a concave form in which the first surface comprises an internal surface and the second surface comprises an external surface;
performing a second forging step on the three-dimensional body to impart a surface texture over the internal surface;
roughening the internal surface texture to receive a surface coating;
applying a non-stick coating to the internal surface with a thickness so that the surface texture is present after coating.

2. The method of claim 1, wherein the second forging step imparts the surface texture over at least 90% of the internal surface of the concave three-dimensional body.

3. The method of claim 1, wherein the second forging step creates the surface texture over the entire internal surface of the three-dimensional body.

4. The method of claim 1, wherein the non-stick coating forms a layer of 50 μm or less over the internal surface.

5. The method of claim 1, wherein the second forging step comprises pressing a die onto the internal surface, the die having a pre-determined pattern on its outer surface that is an inverse of the surface texture imparted onto the internal surface of the three-dimensional body.

6. The method of claim 1, wherein the first forging step forms a base and side wall of the three-dimensional body, and wherein the second forging step creates the surface texture on the internal surface over both the base and side wall.

7. The method of claim 6, wherein the texture is present over the internal surface where the base meets the side wall, e.g. over a curved transition between the base and side wall.

8. The method of claim 1, wherein the roughening of the internal surface texture creates microscopic texture therein on a length scale that is at least an order of magnitude smaller than the surface texture.

9. A cookware article comprising:
a three-dimensional body of concave form having internal and external surfaces, the body comprising an underlying metallic material and a non-stick coating layer over the internal surface;
a surface texture pressed into the underlying metallic material of the body, the surface texture comprising a pattern of discrete raised portions spaced by valleys therebetween, said pattern extending over the internal surface;
the non-stick coating layer overlying the textured surface, the non-stick coating layer having a thickness such that the pattern of the surface texture is present in the surface coating.

10. The cookware article of claim 9, wherein the texture comprises an irregular pattern.

11. The cookware article of claim 9, wherein the surface texture is continuous over the entirety of the internal surface.

12. The cookware article of claim 9, wherein the plurality of raised portions are each surrounded by a valley.

13. The cookware article of claim 12, wherein the valleys form a continuous network over the surface texture.

14. The cookware article of claim 13, wherein the raised portions and valleys have curved sides.

15. The cookware article of claim 9, wherein the raised portions comprise irregular shapes in plan.

16. The cookware article of claim 9, wherein the raised portions have a width in the range of 0.5 mm to 5 mm.

17. The cookware article of claim 12, wherein the height difference between any raised portion and any valley is in the range of 0.2 mm to 0.8 mm, or 0.3 mm to 0.5 mm.

18. The cookware article of claim 9, wherein the raised portions are arched in sectional profile.

19. The cookware article of claim 9, wherein the underlying metallic material comprises aluminium.

20. The cookware article of claim 9, wherein the surface texture of underlying metallic material has a roughened surface at the interface with the non-stick coating.
